(19) United States
(12) Patent Application Publication
(10) Pub. No.: US 2006/0245845 A1
(43) Pub. Date: Nov. 2, 2006

(54) Installation for the recovery of a polluting fluid contained in at least one transverse section of the tanks of a sunken vessel

(76) Inventor: Jean-Luc Dabi, Seneffe (BE)

Correspondence Address: CANTOR COLBURN, LLP, 55 GRIFFIN ROAD SOUTH, BLOOMFIELD, CT, 06002, US

(21) Appl. No.: 10/541,632

(22) PCT Filed: Dec. 16, 2003
(86) PCT No.: PCT/FR03/03742

§ 371 Date: Apr. 17, 2006

(30) Foreign Application Priority Data
Jan. 3, 2003 (FR) 03/00044

(51) Int. Cl. B65G 67/60

(52) U.S. Cl. 414/137.9

(57) ABSTRACT

The present invention relates to an installation for the retrieval of a pollutant fluid contained in at least one section of transverse tanks of a sunken ship, this installation including means of introducing water into the section; means of delivering the pollutant fluid to the outside of the section, at least one connecting pipe coming from an emergency ship being able to be connected to one of the means of delivery, a plurality of fixed pipes positioned such that their first ends emerge at least at the level of each one of the corners of the ends of the section and in that their second ends are each attached to a valve which, on the one hand, is housed in a compartment fixed above the floatation line of the sunken ship and, on the other hand, can be controlled from the outside of the sunken ship.

The present invention relates to an installation for the retrieval of a pollutant liquid contained in at least one section of transverse tanks of a sunken ship.

Following recent shipwrecks of ships carrying pollutant fluids, a simple and reliable system for the retrieval of a pollutant fluid contained in the tanks of a sunken ship has been proposed in the patent application WO 02/057131, lodged in the name of Environment Technical Group and designating Monsieur DABI as the inventor.

This retrieval system comprises a compartment in each of the tanks of the ship on the seabed, this compartment housing several flow pipes and a float element capable of being ejected out of the sunken ship. More precisely, for each compartment, this system comprises an evacuation pipe for the pollutant fluid comprising a first end connected to the tank and a second end connected to the float element. This second end can then be withdrawn a sufficient distance from the sunken ship by using a cable to which the float element is attached. For each compartment, this system also has a suction pipe and an injection pipe, both being connected to the evacuation pipe and respectively provided with a first end floating on the surface of the pollutant liquid contained in the tank, and a first weighted end disposed in the bottom of the said tank. Finally, for each compartment, this system comprises a connecting pipe coming from a emergency ship on the surface and comprising, on the one hand, a first end connected by interlocking in the second end of the evacuation pipe and, on the other hand, a second end connected to a pump installed on the emergency ship. In operation, pressurized water is injected from the emergency ship into the bottom of the tank via the injection pipe. The pollutant fluid is then delivered to the emergency ship via the suction pipe, the evacuation pipe and the connection pipe.

This retrieval system however has a disadvantage consisting of the fact that, when the ship has sunk, it is not easy to gain access from the exterior to the compartments housed in the tanks. Another disadvantage is the fact that, although it is possible to provide the installation of such compartments in the tanks when the ship is being constructed, it is however very difficult to carry out such an installation on an existing ship. Moreover, as the compartments are stored inside the tanks, sealing and safety problems can arise. Furthermore, as this system necessarily provides, on the one hand, for the withdrawal of the second end of the evacuation pipe from the tank and, on the other hand, for raising the second end of the injection pipe to the surface, this results in the connection between the connecting pipe and the evacuation pipe being relatively complex to achieve. Finally, it is not necessary to weight the second end of the injection pipe since the density of the water introduced under pressure is higher than that of the pollutant fluid.

The purpose of the present invention is to add a refinement to the retrieval system described above and consists in an installation for the retrieval of a pollutant fluid contained in at least one section of transverse tanks of a sunken ship, this installation comprising means of introducing pressurized water into the section and means of delivering the pollutant fluid to the outside of the section, at least one connecting pipe coming from an emergency ship being able to be connected to one of the means of delivery, characterized in that it comprises a plurality of fixed pipes each one having a first end and a second end, these fixed pipes being positioned such that their first ends emerge at least at the level of each one of the corners of the ends of the section of tanks and in that their second ends are each attached to a valve which, on the one hand, is housed in a compartment fixed above the floatation line of the sunken ship and, on the other hand, can be controlled from the outside of the sunken ship, each of the said fixed pipes being able, depending on the position of the sunken ship on the seabed, to constitute a means of introduction of pressurized water into the inside of the section or a means of delivery of the pollutant fluid to the exterior of the said section.

In fact, as each of the compartments containing valves are situated above the floatation line of the sunken ship, an R.O.V. (remote controlled submarine robot) or a diver can much more easily gain access to these compartments and thus proceed with the connection and control operations. Furthermore, as these compartments are preferably fixed on the deck of the ship, the installation on an existing ship is relatively easy and the possible sealing and safety problems are solved. Furthermore, given, on the one and, that the end of the fixed pipe emerges in each corner of the ends of the section of transverse tanks and, on the other hand, that each fixed pipe is connected to a valve at its second end, it is no longer necessary to provide for the raising of one of the ends of the injection pipe in order to allow the introduction of pressurized water from the emergency ship. In fact, the R.O.V. or the diver can directly control the opening at choice of one or more valves housed in compartments accessible from outside of the ship. The fixed pipe or pipes associated with this valve or these valves consequently act like introduction pipes, the seawater at hydrostatic pressure surging through the said valves and then penetrating along each of these fixed pipes and finally being introduced into the section of transverse tanks. As seawater has a density higher that that of the pollutant fluid, this results in the latter being forced by the seawater to the highest point of the section of transverse tanks. This pollutant fluid is then driven to penetrate into at least one other fixed tube, acting as a delivery pipe whose first end is located in the highest end corner of the section of transverse tanks. This pollutant fluid is then delivered along this fixed pipe towards the associated compartment and is then delivered along the connecting pipe, to which the second end of the fixed delivery pipe is connected, towards the surface where the emergency ship is located and, finally, can be discharged from the connecting pipe into the tanks of the emergency ship using a pump mounted on the latter.

Preferably, a pair of fixed pipes can be connected to each compartment containing two valves, each pair of fixed pipes comprising, on the one hand, a first fixed short pipe emerging at the top part of the section of tanks and, on the other hand, a second fixed pipe emerging at the bottom part of the section of tanks and having a length greater than the height of the tanks. Advantageously, four separate compartments containing valves are associated with each section of transverse tanks of the ship.

It must be understood in the context of the present invention that each short pipe may not emerge in the section of transverse tanks with which it is associated. In fact, when a compartment is positioned in the proximity of one of the end corners of the section of transverse tanks, the short pipe can consist of a channel formed inside the compartment, this channel having a first end in the form of a simple orifice formed in the bottom of the compartment at the level of an end corner of the section, and a second end accessible from outside of the compartment.

An installation according to the invention can be adapted to any type of section of transverse tanks, for example a section of transverse tanks comprising several tanks able to connect with each other after opening valves provided in the walls separating the said tanks. Preferably, these valves are positioned in the bottom part and in the top part of each of the walls separating the tanks of a section.

Obviously, if the tanks cannot connect with each other, it is sufficient to provide for a first end of a fixed pipe to emerge in each of the corners of each tank. In this case, each tank can be emptied independently of the other tanks in the same transverse section.

As a variant, it can be provided that each tank is separated from an adjacent tank by a partition and that this separating partition is traversed, in the vicinity of each of its corners, by a connector to which is fitted a weighted valve capable, depending of the position of the ship, of closing or opening the through passage section of the said connector.

Preferably, the valves housed in the compartments and, if applicable, the valves provided in the walls separating the said tanks, are parallel-slide gate valves.

The invention will be better understood with the help of the following detailed description which is given hereafter with reference to the drawing in which:

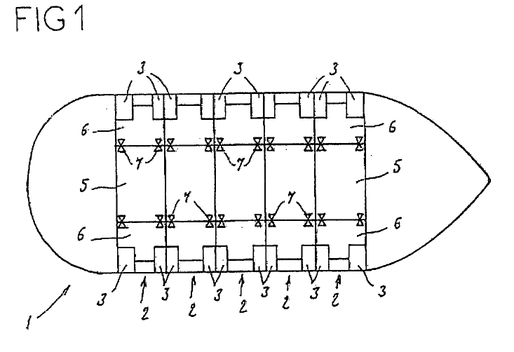

FIG. 1 is a diagrammatic plan view of a ship comprising several sections of transverse tanks, equipped with an installation according to the invention;

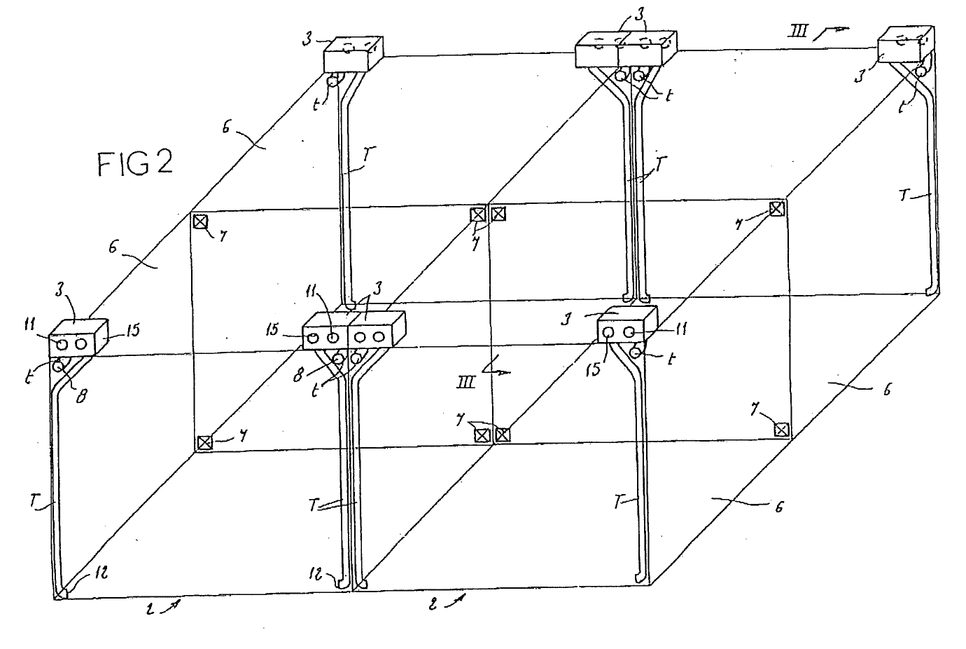

FIG. 2 is a partial diagrammatic view in perspective of two sections of transverse tanks of the ship shown in FIG. 1 with the central tanks omitted;

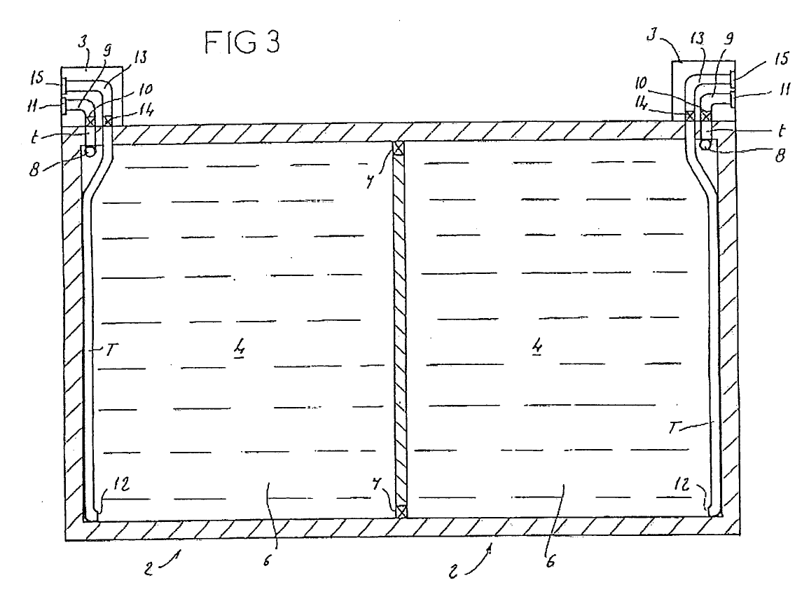

FIG. 3 is a diagrammatic view in cross-section through the line III-III of the section of transverse tanks shown in FIG. 2.

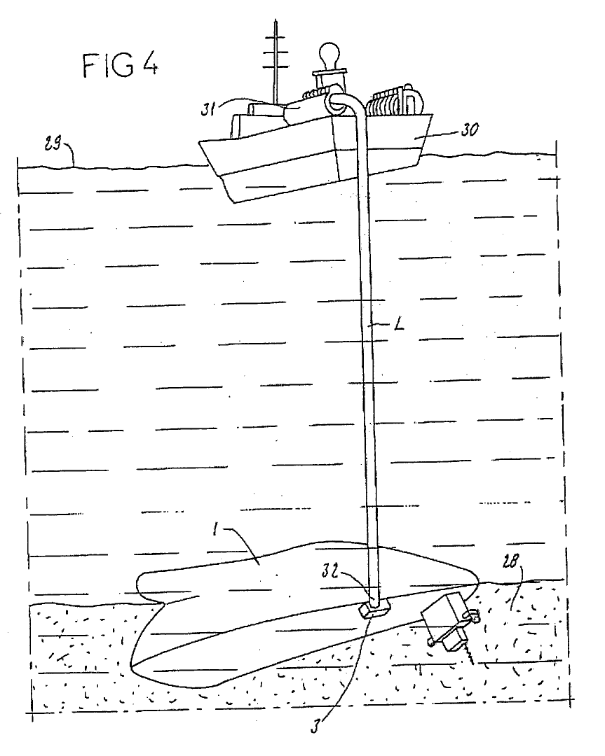

FIG. 4 is a diagrammatic view of the installation according to the invention after connecting a connecting pipe coming from an emergency ship to a compartment of the sunken ship.

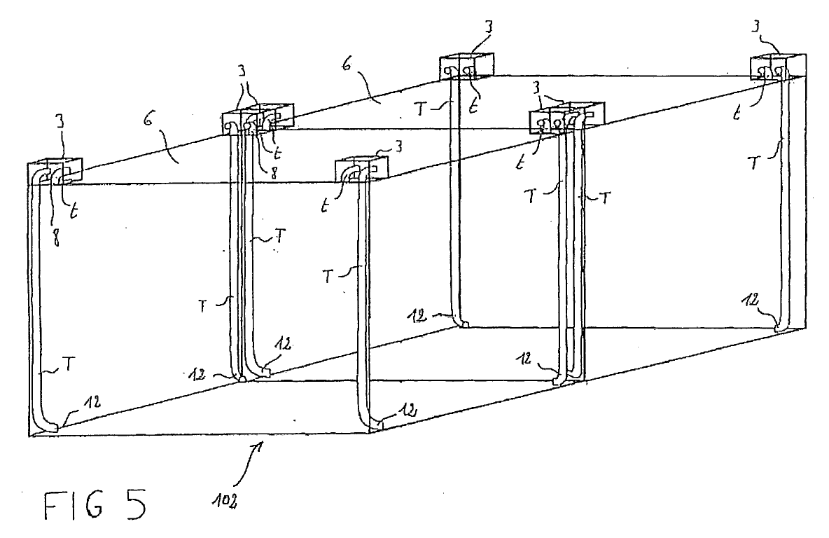

FIG. 5 is a partial diagrammatic view in perspective of another section of transverse tanks, with the central tank omitted.

FIG. 6 is a partial diagrammatic view in perspective of another section of transverse tanks, before the ship grounds on the seabed.

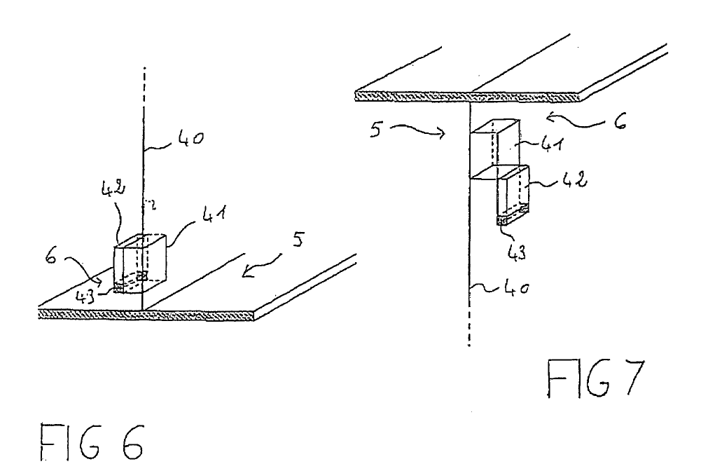

FIG. 7 is a partial diagrammatic view in perspective of the section of transverse tanks shown in FIG. 6, after the ship has grounded with its deck on the seabed.

FIG. 1 is a diagrammatic plan view of a ship 1 having five sections 2 of transverse tanks of substantially parallel epipedic shape two which compartments 3 are connected.

More precisely, each section 2 of transverse tanks contains a pollutant liquid 4 and consists of a central tank 5 and two lateral tanks 6, these various tanks 5, 6 being able to connect with each other after the opening of parallel-slide gate valves 7 provided in the walls separating these tanks 5, 6. The opening of each of these valves 7 can be controlled from outside of the ship 1.

The compartments 3 are positioned on the deck (not shown) of the ship 1 and are connected to the lateral tanks 6 of the end sections 2 and to the lateral tanks 6 of the intermediate sections 2. Thus, whatever the position of the ship 1 on the seabed may be, each of the sections 2 of transverse tanks can be emptied by the intermediary of at least two compartments 3.

Referring to FIGS. 2 and 3, it can be seen that a fixed, short, metal or flexible pipe t and that a fixed, metal or flexible pipe T, having a length greater than the height of the tanks 5, 6, connect each compartment 3 to a lateral tank 6 of a section 2. In cross-section, the diameter of a fixed pipe t is identical to that of a fixed pipe T.

More precisely, each short fixed pipe t has, on the one hand, a first end 8 emerging in the vicinity of an end corner located in the top part of the associated section 2 and, on the other hand, a second end 9 connected to a parallel-slide gate valve 10 housed in the compartment 3 and accessible from outside of the ship 1 by the intermediary of a fast connector 11.

Each large-sized fixed pipe T has, on the one hand, a first end 12 emerging in the vicinity of an end corner located in the bottom part of the associated section 2 and, on the other hand, a second end 13 connected to a parallel-slide gate valve 14 housed in the compartment 3 and accessible from outside of the ship 1 by the intermediary of a fast connector 15.

In order to facilitate the understanding of the invention, the ship 1 shown in FIG. 4 comprises only a single section 2 of lateral tanks as shown in FIG. 3. When the ship 1 has sunk and is resting on the bottom 28 of the sea 29, an emergency ship 30 positions itself substantially vertically above the ship 1 after locating the latter. A connecting pipe L is then disposed between the emergency ship 30 and one of the accessible compartments 3 of the ship 1. More precisely, this connecting pipe L has, on the one hand, a first end connected to a pump 31 installed on the emergency ship 30 and, on the other hand, a second end 32 which is connected, by an R.O.V. or by a diver, to the fast connector 11 of the parallel-slide gate valve 10 that is itself connected to the second end 9 of the fixed pipe t of that compartment 3.

After, on the one hand, opening parallel-slide gate valves 10, 14 housed in the compartment 3 and, on the other hand, valves 7 provided in the walls separating the tanks 5, 6 of the same section 2, seawater 29 at hydrostatic pressure is introduced into the section 2 via the fixed pipe T. Seawater 29 has a density higher than that of the pollutant fluid 4 contained in the section 2 and it is therefore forced by the seawater 29 through the fixed pipe t and the connecting pipe L and then, finally, discharged into the tanks of the emergency ship 30 by means of the pump 31. In the case of very heavy fuel oil, it may be useful to connect a submerged pump at the level of the sunken ship, in order to accelerate the raising of the said fuel oil to the surface.

It should be noted that it would be possible to achieve the same result by connecting this connecting pipe L not to the short fixed pipe t but to the long fixed pipe T. In fact, in this case, the pipe t would act as a pipe for the introduction of seawater 29 at hydrostatic pressure and the pipe T would act as a delivery pump for the pollutant fluid 4 to the exterior of the tanks 5, 6 of the section 2.

In order to accelerate the retrieval of the pollutant fluid 4, it must also be well understood that if several compartments 3 are accessible from outside of the ship 1, it is then possible to connect one of the two fixed pipes t or T of each of these compartments 3 to a separate connecting pipe L, the fixed pipe T or t remaining free then being intended for the introduction of seawater 29 at hydrostatic pressure into the inside of the section 2 that corresponds to it.

Furthermore, for example in the case where two compartments 3 of a section 2 are accessible from outside of the ship 1, it is possible to connect a separate connecting pipe L to each one of the two fixed pipes t, T of one of the two compartments 3, the two fixed pipes t, T of the other compartments 3 remaining free and then being intended for allowing the introduction of seawater 29 at hydrostatic pressure after opening the corresponding valves.

Another type of section 102 of transverse tanks is shown in FIG. 5. This section 102 differs from the section 2 described previously in that it does not comprise any parallel-slide gate valves 7 allowing connection between the central tank 5 and the two lateral tanks 6. Consequently, it is necessary to empty the tanks 5, 6 independently of each other. In order to do this, a compartment 3 is provided at the level of each of the corners of each tank 5, 6, and this results in a first end 8, 12 of a fixed pipe t, T emerging in each of the corners of each tank 5, 6.

However, in order to enhance the reliability of the installation, it can be advantageous to place a compartment 3 in each tank corner 5, 6, even if parallel-slide gate valves 7 are provided to provide connection between the various tanks 5, 6.

Finally, as a replacement for the parallel-slide gate valves 7, and as shown in FIGS. 5 and 6, it is also possible to integrate, at the level of each of the corners of each partition 40 separating the central tank 5 from an adjacent lateral tank 6, a connector 41 to which is fitted a rotary valve 42 provided with a ballast weight 43. In FIG. 5, the ship is resting on its keel and the valve 42 consequently obturates the through passage section of the connector 40 under the effect of the ballast weight 43. If however, as shown in FIG. 6, the ship has come to rest on its deck, the valve 42, under the effect of the ballast weight 43, is caused to pivot about its axis of rotation. This then results in the valve 42 disengaging from the through passage section of the connector 40, which finally makes it possible to establish the connection between the two tanks 5, 6.

Even though the invention has been described with reference to particular example embodiments, it is obvious that it is in no way limited by them and that it comprises all techniques equivalent to the means described and their combinations if they fall within the scope of the invention.

1. Installation for the retrieval of a pollutant fluid contained in at least one section of transverse tanks of a sunken ship, this installation comprising:
means of introducing pressurized water into the section;
means of delivering the pollutant fluid to the outside of the section;
at least one connecting pipe coming from an emergency ship being able to be connected to one of the means of delivery; and
a plurality of fixed pipes each one having a first end and a second end;
wherein the fixed pipes being positioned such that the first ends emerge at least at a level of each corner of ends of the section and;
wherein the second ends are each attached to a pipe valve which, on the one hand, is housed in a compartment fixed above a floatation line of the sunken ship and, on the other hand, can be controlled from outside of the sunken ship; and
wherein each of the said fixed pipes being able, depending on a position of the sunken ship on the seabed, to constitute a means of introduction of pressurized water into the inside of the section or a means of delivery of the pollutant fluid to the exterior of the section.

2. Installation according to claim 1, wherein each compartment containing pipe valves is fixed on a deck of the sunken ship.

3. Installation according to claim 1, wherein a pair of the fixed pipes is connected to each compartment containing two valves.

4. Installation according to claim 3, wherein each pair of fixed pipes comprises, on the one hand, a first short fixed pipe emerging at a top part of the section, and, on the other hand, a second fixed pipe emerging in a bottom part of the section and having a length greater than the height of the tanks.

5. Installation according to claim 1, wherein four separate compartments containing pipe valves, are associated with each section of transverse tanks.

6. Installation according to claim 1, wherein each section of the transverse tanks can be divided into several tanks able to connect with each other after opening wall valves provided in walls separating the said tanks.

7. Installation according to claim 6, wherein the wall valves are positioned in a bottom part and in a top part of each of the walls separating the tanks of a section.

8. Installation according to claim 6, wherein each pipe and wall valve is a parallel-slide gate valve.

9. Installation according to claim 1, wherein a first end of a fixed pipe emerges in each of the corners of each tank.

10. Installation according to claim 9, wherein each tank is separated from an adjacent tank by a partition and this separating partition is traversed, in a vicinity of each of its corners, by a connector to which is fitted a weighted valve capable, depending upon the position of the ship, of closing or opening a through passage section of said connector.
